(19) United States
(12) Patent Application Publication
(10) Pub. No.: US 2018/0115048 A1
(43) Pub. Date: Apr. 26, 2018

(54) VEHICLE ANTENNA AND WINDOW GLASS

(71) Applicant: ASAHI GLASS COMPANY, LIMITED, Tokyo (JP)

(72) Inventor: Osamu KAGAYA, Tokyo (JP)

(73) Assignee: ASAHI GLASS COMPANY, LIMITED, Tokyo (JP)

(21) Appl. No.: 15/789,817

(22) Filed: Oct. 20, 2017

(30) Foreign Application Priority Data
Oct. 25, 2016 (JP) 2016-209079

(51) Int. Cl. H01Q 1/12; H01Q 9/42; H01P 3/00; H01Q 9/40; H01Q 5/40; H01Q 1/38

(52) U.S. Cl. CPC H01Q 1/1271; H01Q 9/42; H01Q 1/38; H01Q 9/40; H01Q 5/40; H01P 3/003

(57) ABSTRACT

A vehicle antenna includes a coplanar wave guide including a planar dielectric body, a signal conductor arranged on the dielectric body, and a pair of ground conductors that hold both sides of the signal conductor via slots; a ground plane provided on an opposite side of the dielectric body from the signal conductor and the ground conductors; and an inverted-F antenna including a power feeding unit coupled to the signal conductor, a shorting unit coupled to one of the ground conductors, and a radiation unit coupled to an end portion of the power feeding unit and coupled to an end portion of the shorting unit, the radiation unit extending in a prescribed extension direction. The radiation unit is positioned on the ground plane side with respect to the dielectric body.

### CROSS-REFERENCE TO RELATED APPLICATION

The present application is based on and claims benefit of priority under 35 U.S.C. § 119 of Japanese Patent Application No. 2016-209079, filed Oct. 25, 2016. The contents of the application are incorporated herein by reference in their entirety.

### BACKGROUND OF THE INVENTION

### 1. Field of the Invention

The disclosure herein generally relates to a vehicle antenna and a window glass.

### 2. Description of the Related Art

Conventionally, antennas for vehicle arranged on surfaces of window glasses of vehicles or surfaces of insulating members of vehicle bodies have been known (See, for example, Japanese Unexamined Patent Application Publication No. 2007-53505).

### SUMMARY OF THE INVENTION

As a wireless communication system used for an ITS (Intelligent Transport Systems), for example, a DSRC (Dedicated Short Range Communication) has been known. The DSRC is used for road-to-vehicle communication or vehicle-to-vehicle communication. It is desirable for the antenna of the ITS, such as the DSRC, used in the vehicle to have antenna gain greater in a specific direction (e.g. front and rear direction of a vehicle) taking into account the positional relationship between a communication partner and the host vehicle.

Embodiments of the present disclosure aim to provide a vehicle antenna that can enhance an antenna gain in a specific direction, and a window glass provided with the vehicle antenna.

In order to achieve the above-described aim, an embodiment of the present invention provides

a vehicle antenna including

a coplanar wave guide including a planar dielectric body, a signal conductor arranged on the dielectric body, and a pair of ground conductors that hold both sides of the signal conductor via slots;

a ground plane provided on an opposite side of the dielectric body from the signal conductor and the ground conductors; and

an inverted-F antenna including a power feeding unit coupled to the signal conductor, a shorting unit coupled to one of the ground conductors, and a radiation unit coupled to an end portion of the power feeding unit and coupled to an end portion of the shorting unit, the radiation unit extending in a prescribed extension direction,

the radiation unit being positioned on the ground plane side with respect to the dielectric body, and provides a window glass provided with the vehicle antenna.

According to the present embodiment, the antenna gain in a specified direction can be enhanced.

### BRIEF DESCRIPTION OF THE DRAWINGS

FIG. 1 is a perspective view depicting an example configuration of an antenna for a vehicle according to a first embodiment;

FIG. 2 is a front view depicting an example configuration of the vehicle antenna according to the first embodiment;

FIG. 3 is a side view depicting an example configuration of the vehicle antenna according to the first embodiment;

FIG. 4 is a rear view depicting an example configuration of the vehicle antenna according to the first embodiment;

FIG. 5 is a perspective view depicting an example configuration of a vehicle antenna according to a second embodiment;

FIG. 6 is a front view depicting an example configuration of the vehicle antenna according to the second embodiment;

FIG. 7 is a side view depicting an example configuration of the vehicle antenna according to the second embodiment;

FIG. 8 is a rear view depicting an example configuration of the vehicle antenna according to the second embodiment;

FIG. 9 is a front view depicting an example configuration of a vehicle antenna according to a third embodiment;

FIG. 10 is a rear view depicting an example configuration of the vehicle antenna according to the third embodiment;

FIG. 11 is a cross-sectional diagram depicting an example configuration of the vehicle antenna for vehicle according to the third embodiment;

FIG. 12 is a cross-sectional diagram depicting an example configuration of a window glass;

FIG. 13 is a diagram depicting example results of measurement for a reflection coefficient;

FIG. 14 is a diagram depicting an example of results of measurement for an antenna gain of a vehicle antenna attached to a front windshield;

FIG. 15 is a diagram depicting example results of measurement for directivity of the vehicle antenna attached to the front windshield;

FIG. 16 is a diagram depicting example results of measurement for an antenna gain of a vehicle antenna attached to a rear windshield; and

FIG. 17 is a diagram depicting example results of measurement for directivity of the vehicle antenna attached to the rear windshield.

### DETAILED DESCRIPTION OF THE PREFERRED EMBODIMENTS

In the following, an embodiment of the present invention will be described with reference to the accompanying drawings. In the drawings for describing the embodiment, in the absence of a specific description with respect to a direction, the direction refers to a direction indicated in the drawings. Reference directions in the respective drawings correspond to directions of symbols or numerals. Moreover, a direction, such as parallel, orthogonal or the like allows for deviations so long as the effects of the present invention are maintained. Moreover, a window glass, to which the present invention can be applied, includes, for example, a front windshield arranged in an anterior part of a vehicle. The window glass may be a rear windshield arranged in a posterior part of the vehicle, a side windshield arranged in a side part of the vehicle, a roof glass arranged in a ceiling part of the vehicle, or the like.

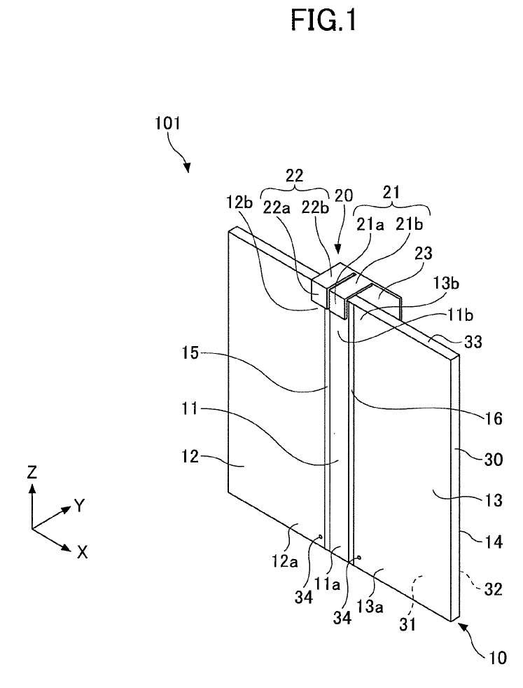

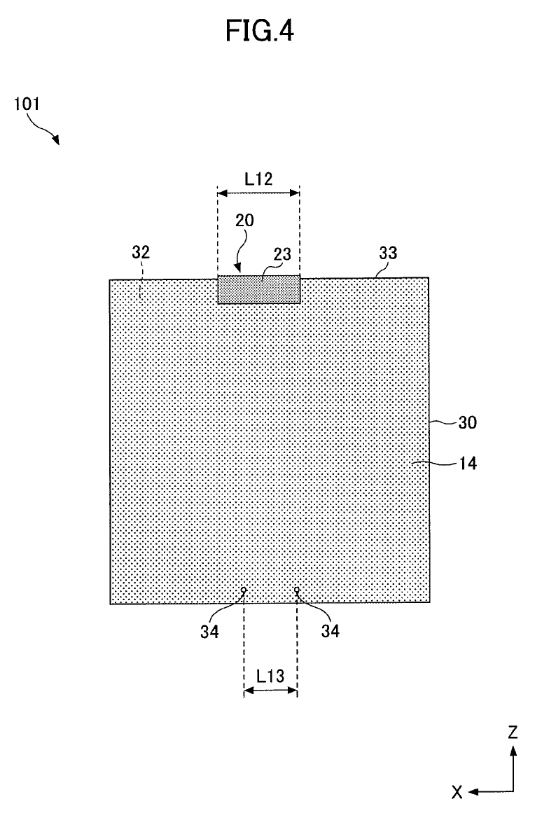

FIGS. 1 to 4 are diagrams depicting an example of the vehicle antenna according to a first embodiment, and indicate a perspective view, a front view, a side view, and a rear view, respectively. The antenna 101 illustrated in FIGS. 1 to 4, is an example of a vehicle antenna. In the following, with reference to FIGS. 1 to 4, the configuration of the antenna 101 will be described. The antenna 101 includes a CPWG (Coplanar Waveguide with Ground plane) 10 and an inverted-F antenna 20.

The CPWG 10 includes a coplanar wave guide that has a dielectric body, a signal conductor 11, ground conductors 12 and 13; and a ground plane 14 provided on the opposite side of a dielectric substrate 30 from the signal conductor 11 and the ground conductors 12 and 13. The CPWG 10 includes, for example, the signal conductor 11 formed on a surface 31 of the dielectric body, a pair of ground conductors 12 and 13 formed on the surface 31 so as to hold the signal conductor 11 from both sides, and the ground plane 14 formed on opposite side of dielectric body from the surface 31. A slot 15 is formed between the signal conductor 11 and one of the ground conductor 12, and a slot 16 is formed between the signal conductor 11 and the other ground conductor 13.

The surface 31 is an example of a first surface on which the signal conductor 11 and the ground conductors 12 and 13 are formed. The surface 31 is, for example, one surface of the dielectric substrate 30. The surface 32 is an example of a second surface of the dielectric body that is located on an opposite side to the first surface. The surface 32 is, for example, the other surface of the dielectric substrate 30 (i.e. a surface of the dielectric substrate 30 opposite to the one surface).

The dielectric substrate 30 is an example of a dielectric body. The dielectric substrate 30 is, for example, a resin printed board having a square shape. Specifically, the dielectric substrate 30 includes, for example, a glass epoxy substrate in which a copper foil attached to an FR4 (Flame Retardant Type 4). The dielectric substrate 30 has edge surface 33. The edge surface 33 is a substrate end surface, at which the slots 15 and 16 open on a side of an end portion 11b of the signal conductor 11.

Power is supplied through one end portion 11a of the signal conductor 11, one end portion 12a of the ground conductor 12, and one end portion 13a of the ground conductor 13. For example, to the one end portion 11a of the signal conductor 11, one tip portion of an internal conductor (signal line) of a coaxial cable is coupled electrically. To the one end portion 12a of the ground conductor 12 and to the one end portion 13a of the ground conductor 13, one tip portion of an external conductor of the coaxial cable is coupled electrically. To the other tip portion of the coaxial cable, a transmission/reception circuit is coupled.

The ground conductors 12 and 13 may be coupled to a ground plane 14 conductively. For example, the ground conductors 12 and 13 may be coupled conductively to the ground plane 14 via a through hole 34 penetrating the dielectric substrate 30. The through hole 34 is arranged at the end portions 12a and 13a.

The inverted-F antenna 20 includes a power feeding unit 21 coupled to the signal conductor 11, a shorting unit 22 coupled to the ground conductor 12, and a radiation unit 23 coupled to an end portion of the power feeding 21 unit and an end portion of the shorting unit 22 and extending in a prescribed direction.

The inverted-F antenna 20 does not contact the ground plane 14. Specifically, the power feeding unit 21, the shorting unit 22, and the radiation unit 23 do not contact the ground plane 14. For example, the ground plane 14 is formed on the surface 32 separated from the edge surface 33 of the dielectric substrate 30 so that the power feeding unit 21, the shorting unit 22, and the radiation unit 23 do not contact an edge portion of the ground plane 14 on the edge surface 33 side.

The power feeding unit 21 includes a connection part 21a electrically coupled to the end portion 11b of the signal conductor 11 by a solder or the like, and an extension part 21b that extends from the connection part 21a. An end portion on an opposite side of the extension part 21b from the connection part 21a is coupled to an intermediate portion of the radiation unit 23. The power feeding unit 21 is formed in L shape by the connection part 21a and the extension part 21b.

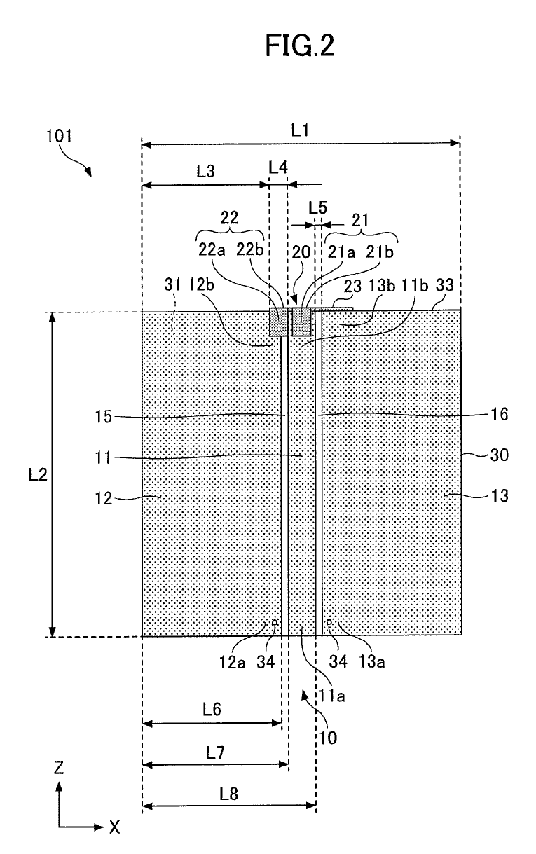

The connection part 21a is coupled to the signal conductor 11, but is not coupled to the ground conductors 12 and 13. The connection part 21a is, for example, joined with the end portion 11b of the signal conductor 11. In a planar view of the surface 31 (i.e. by a viewpoint illustrated in FIG. 2), the connection part 21a overlaps with the end portion 11b of the signal conductor 11. The connection part 21a may overlap with at least one of the slots 15 and 16.

The extension part 21b extends so as to go around an external surface of the dielectric substrate 30 (specifically, the edge surface 33 of the dielectric substrate 30). The extension part 21b may or may not contact the edge surface 33.

The shape of the power feeding unit 21 is not limited to the L-shape, but may be U-shape, or may be J-shape.

The shorting unit 22 includes a connection part 22a electrically coupled to the other end portion 12b of the ground conductor 12 by a solder or the like, and an extension part 22b that extends from the connection part 22a. An end portion of the extension part 22b on an opposite side from the connection part 22a is coupled to one end portion of the radiation unit 23. The shorting unit 22 is formed in L-shape by the connection part 22a and the extension part 22b.

The connection part 22a is coupled to the ground conductor 12, but is not coupled to the signal conductor 11 and the ground conductor 13. The connection part 22a is, for example, joined with the end portion 12b of the ground conductor 12. In a planar view of the surface 31, the connection part 22a overlaps with the end portion 12b of the ground conductor 12. The connection part 22a may overlap with the slot 15.

The extension part 22b extends so as to go around an external surface of the dielectric substrate 30 (specifically, the edge surface 33 of the dielectric substrate 30). The extension part 22b may or may not contact the edge surface 33.

The shape of the shorting unit 22 is not limited to the L-shape, but may be U-shape, or may be J-shape.

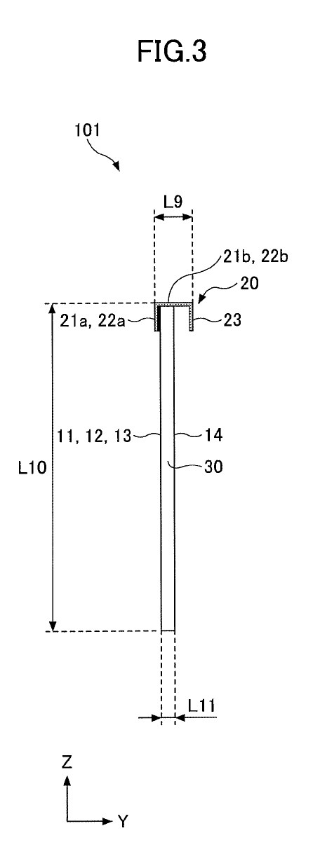

The radiation unit 23 is positioned on the ground plane 14 side with respect to the dielectric substrate 30. That is, in a side view of the antenna 101 illustrated in FIG. 3, the radiation unit 23 is positioned to the right of the ground plane 14 side, with respect to the dielectric substrate 30. According to the above-described configuration, the antenna gain of the antenna 101 in a Z-axis direction (direction parallel to a longitudinal direction of the signal conductor 11, particularly, a direction on an inverted F-antenna 20 side among Z-axis directions) parallel to the ground plane 14 is greater than the antenna gain in a Y-direction orthogonal to the ground plane 14. Particularly, to increase the antenna gain of the antenna 101 in the Z-axis direction, the radiation unit 23 preferably has a portion that faces the ground plane 14, as illustrated in FIG. 3.

The radiation unit 23 extends, for example, in a direction orthogonal to the longitudinal direction of the signal conductor 11, and parallel to the ground plane 14. A length L12 of the radiation unit 23 in the direction parallel to the ground plane 14 is preferably less than or equal to a length L1 of the ground plane 14, and more preferably less than the length L1. When the length L12 is less than or equal to the length L1, the degree of diffusion of energy radiated from the radiation unit 23 decreases, and the degree of return of energy radiated from the radiation unit 23 to the ground plane 14 increases. When the length L12 is less than or equal to the length L1, the antenna gain of the inverted F-antenna 20 is improved, thereby improving the antenna gain of the antenna 101.

Moreover, the length L12 of the radiation unit 23 in the direction parallel to the ground plane 14 is preferably greater than or equal to a sum W of a conductor width of the signal conductor 11, a slot width of the slot 15, and a slot width of the slot 16. In FIG. 2, the conductor width of the signal conductor 11 is equivalent to (L8-L7), the slot width of the slot 15 is equivalent to (L7-L6), and the slot width of the slot 16 is equivalent to L5. When the length L12 is greater than or equal to the sum W the antenna gain of the inverted F-antenna 20 is improved, thereby improving the antenna gain of the antenna 101.

In the embodiment illustrated in the drawings, the radiation unit 23 is separated from the ground plane 14 and does not contact the surface 32 of the dielectric substrate 30. However, the radiation unit 23 may contact the surface 32 of the dielectric substrate 30 in a state where the radiation unit 23 is insulated from the ground plane 14. For example, in FIG. 3, the thickness L11 of the dielectric substrate 30 is increased and/or lengths of the extension parts 21b and 22b are decreased, and at least a part of an upper end portion of the ground plane 14 is offset downward. According to the above-described configuration, the radiation unit 23 contacts the surface 32 of the dielectric substrate 30 in the state where the radiation unit 23 is insulated from the ground plane 14. As a result, the mounting strength of the inverted F-antenna 20 on the dielectric substrate 30 is improved.

Moreover, at least a part of the inverted F-antenna 20 may be formed by a conductor pattern on the dielectric substrate 30. For example, the connection part 21a may be a pattern integrated with the end portion 11b of the signal conductor 11. The extension part 21b may be formed on an edge surface 33 with a side metal pattern. The connection part 22a may be a pattern integrated with the end portion 12b of the ground conductor 12. The extension part 22b may be formed on the edge surface 33 with a side metal pattern. The radiation unit 23 may be formed on the surface 32 by a conductor pattern in a state where the radiation unit 23 is insulated from the ground plane 14.

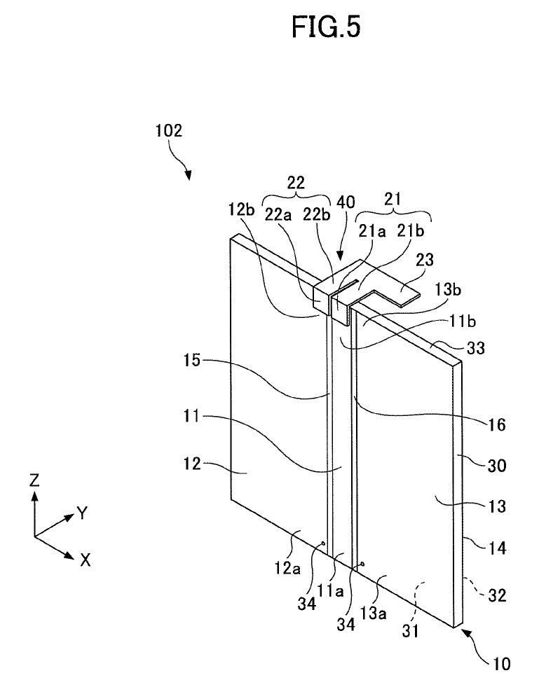

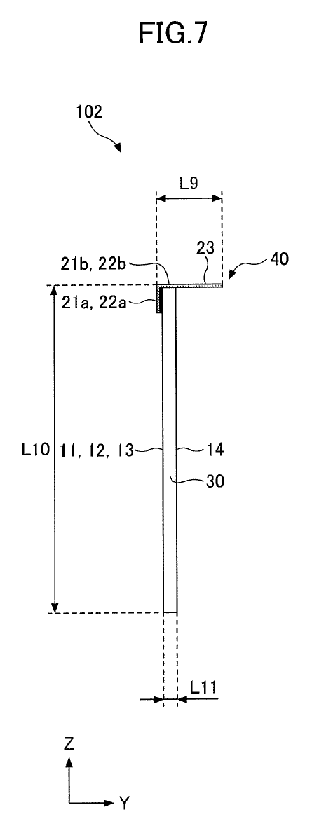

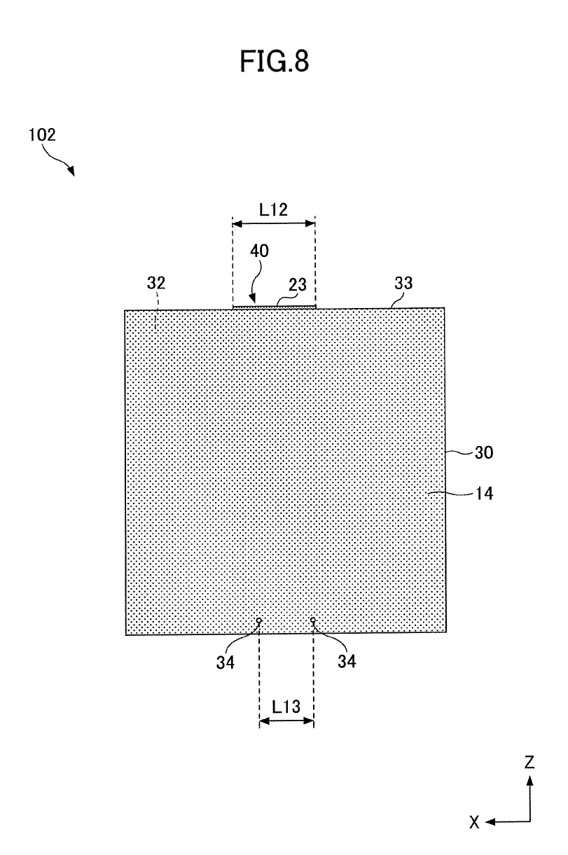

FIGS. 5 to 8 are diagrams depicting an example of a vehicle antenna according to a second embodiment, and indicate a perspective view, a front view, a side view, and a rear view, respectively. The antenna 102 illustrated in FIGS. 5 to 8, is an example of a vehicle antenna. In the following, with reference to FIGS. 5 to 8, the configuration of the antenna 102 will be described. The antenna 102 includes a CPWG (Coplanar Waveguide with Ground plane) 10 and an inverted F-antenna 40. Among the configuration of the second embodiment, explanation of the same configuration and effect as the first embodiment will be omitted by incorporating the above-described description.

The antenna 102 according to the second embodiment differs from the antenna 101 according to the first embodiment in that the radiation unit 23 of the inverted F-antenna 40 does not face the ground plane 14. Instead the radiation unit 23 is parallel to the edge surface 33. That is, the radiation unit 23 is arranged orthogonally with respect to the ground plane 14 (inclination angle is 90°). However the inclination angle of the radiation unit 23 to the ground plane 14 is not limited to 90°, and may be another inclination angle. Also in the second embodiment, as with the first embodiment, the radiation unit 23 is located on the ground plate 14 side of the dielectric substrate 30.

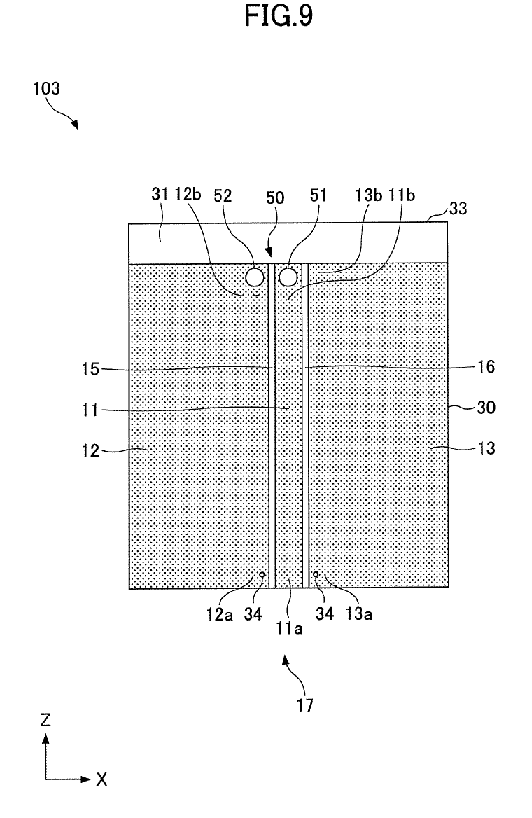

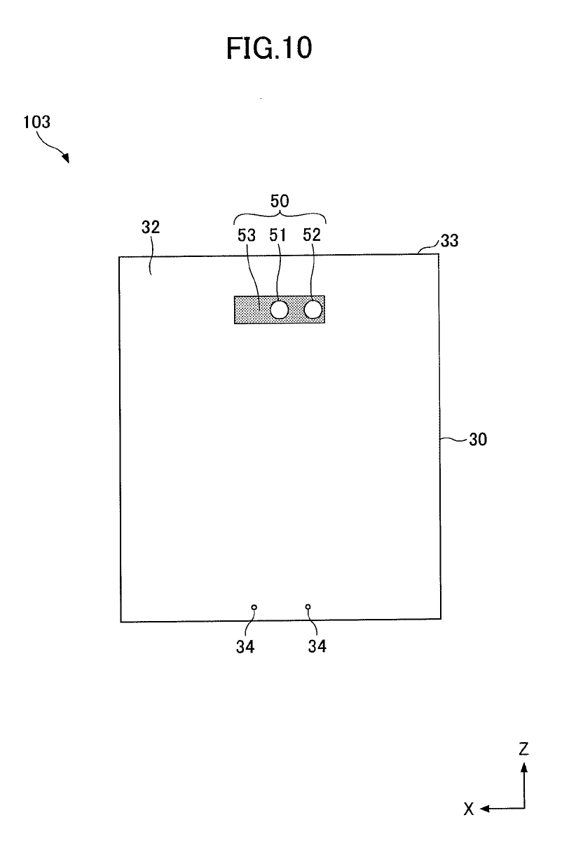

FIGS. 9 to 11 are diagrams depicting an example of a vehicle antenna according to a third embodiment, and indicate a front view, a rear view, and a cross-sectional view, respectively. The antenna 103 illustrated in FIGS. 9 to 11, is an example of a vehicle antenna. The antenna 103 includes a CPWG (Coplanar Waveguide with Ground plane) 17 and an inverted F-antenna 50. Among the configuration of the third embodiment, explanation of the same configuration and effect as the first and second embodiments will be omitted by incorporating the above-described description.

The antenna 103 according to the third embodiment is differs the antennas 101 and 102 according to the first and second embodiments in that a ground plane 54 of the CPWG 17 is arranged inside the dielectric substrate 30 and the shape of the inverted F-antenna is differs those of the antennas 101 and 102.

The CPWG 17 includes a coplanar wave guide having a dielectric body, a signal conductor 11, and ground conductors 12 and 13; and a ground plane 54 provided on the opposite side of a dielectric body from the signal conductor 11 and the ground conductors 12 and 13 (specifically, the dielectric substrate 30).

The inverted F-antenna 50 includes a power feeding unit 51 coupled to the signal conductor 11 at the end portion 11b, a shorting unit 52 coupled to the ground conductor 12 at the end portion 12b, and a radiation unit 53 coupled to an end portion of the power feeding unit 51 and an end portion of the shorting unit 52.

In a planar view of the surface 31, upper end portions of the signal conductor 11, and the ground conductors 12 and 13 are offset downward with respect to the edge surface 33 of an upper part of the dielectric substrate 30. However, such offset of the upper end portions is not required.

The power feeding unit 51 and the shorting unit 52 extend inside the dielectric substrate 30. According to the above-described configuration, the antenna 103 can be downsized. The power feeding unit 51 and the shorting unit 52 are conductively coupled to the radiation unit 53 via a through hole penetrating through the dielectric substrate 30, for example.

An end portion of the power feeding unit 51 is coupled to an intermediate portion of the radiation unit 53. An end portion of the shorting unit 52 is coupled to one end portion of the radiation unit 53.

The shape of the through hole is not limited to a cylinder, and may be a semicylinder. That is, a through hole having a semicylinder shape may be formed on an edge surface of the dielectric substrate 30, and the signal conductor 11 and the ground conductor 12 and 13 may be conductive to the radiation unit 53.

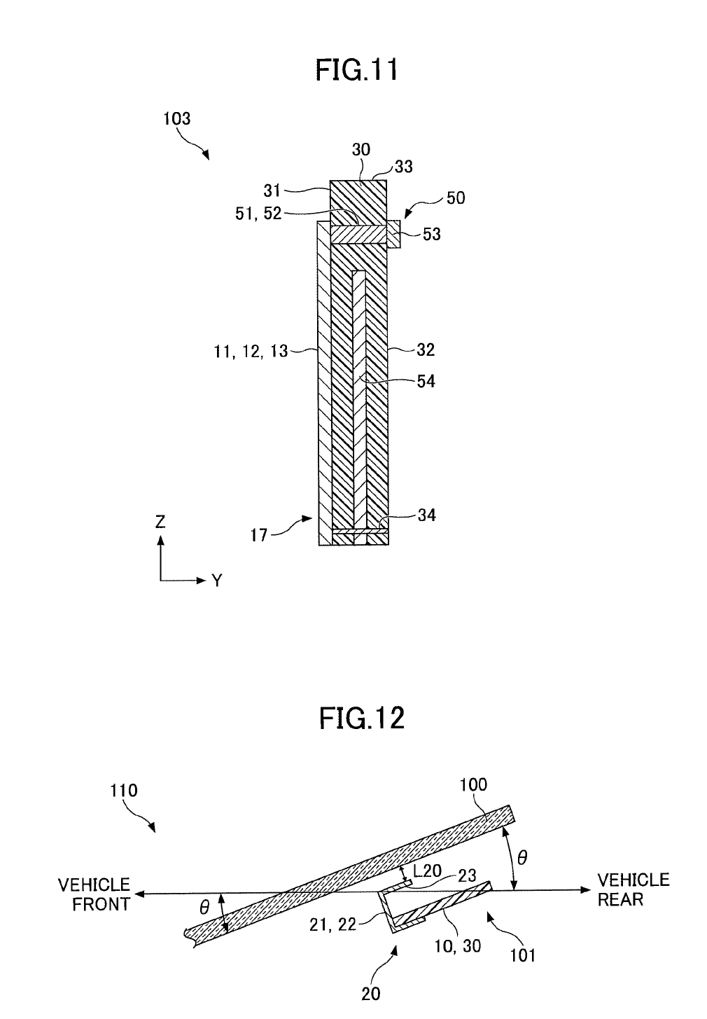

As illustrated in FIG. 11, the radiation unit 53 is located on the surface 32 positioned on the opposite side of the dielectric substrate 30 from the surface 31. Although, in FIG. 11, the radiation unit 53 does not face the ground plane 54, the radiation unit 53 may face the ground plane 54. The radiation unit 53 is formed, for example, on the surface 32 by a conductor pattern.

The through hole 34 penetrates through the dielectric substrate 30 from the surface 31 to the surface 32. However, as long as the through hole 34 has sufficient depth for connecting the ground conductors 12 and 13 with the ground plane 54, the through hole 34 may not penetrated the dielectric substrate 30.

FIG. 12 is a cross-sectional diagram depicting an example of a configuration of a window glass according to the embodiment. The window glass system 110 illustrated in FIG. 12 is an example of a window glass, and includes an antenna 101 and a vehicle window glass 100. FIG. 12 illustrates an antenna 101 according to the first embodiment, but may be replaced by an antenna according to another embodiment, and the same effect as the antenna 101 can be obtained.

FIG. 12 depicts an example of the positional relationship between the vehicle window glass 100 and the antenna 101 in a state where the vehicle window glass 100 is attached to the vehicle at an attachment angle θ with respect to the horizontal direction. FIG. 12 illustrates a case where the vehicle window glass 100 is a front windshield.

The antenna 101 is attached on the vehicle interior side of the vehicle window glass 100 so that a ground plane of the CPW 10 and the radiation unit 23 are parallel with the vehicle window glass 100. When the antenna 101 is attached on the vehicle interior side of the vehicle window glass 100 so that the ground plane of the CPW 10 and the radiation unit 23 are parallel with the vehicle window glass 100, the antenna gain of the antenna 101 within a range of the angle θ in the longitudinal direction of the vehicle is increased compared with the antenna gain in the vehicle vertical direction.

The antenna 101 is attached in a central portion of the upper side of a peripheral region of the vehicle window glass 100. For example, the antenna 101 is attached in a visible light shielding region arranged in the peripheral region of the vehicle window glass 100 (particularly, a convex region formed so as to project toward a central region of a glass surface of the vehicle window glass 100). The visible light shielding region is formed, for example, using black shielding film such as a black ceramic film.

The radiation unit 23 is located between the ground plane of the CPW 10 and the vehicle window glass 100. According to the above-described configuration, the antenna gain of the antenna 101 within a range of the angle θ in the longitudinal direction of the vehicle is increased greater compared with the antenna gain in the vehicle vertical direction.

In addition, the antenna 101 may be attached to the vehicle window glass 100 so that the radiation unit 23 is located on an opposite side from the vehicle window glass 100 with respect to the ground plane of the CPW 10, i.e. on the compartment side.

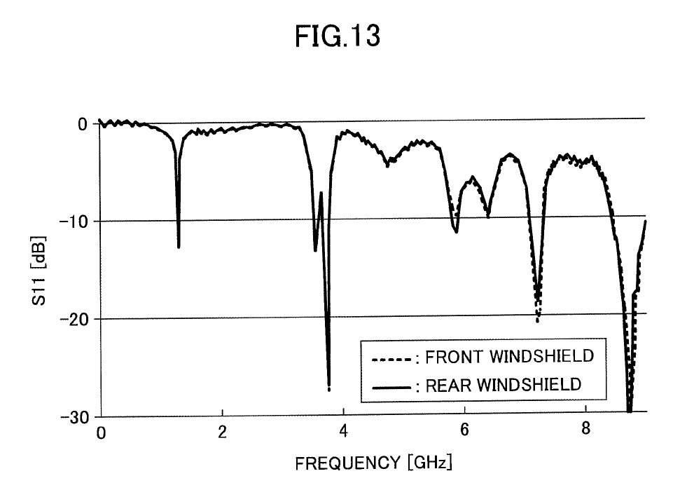

FIG. 13 depicts an example of results of measurement of a reflection coefficient S11 of the antenna 101 when the window glass system 110 is mounted on a front window frame or a rear window frame of an actual vehicle. In the case where the vehicle window glass 100 is a front windshield, a mounting angle θ (an angle formed between the vehicle window glass 100 and the ground) may be 21°. When the vehicle window glass 100 is a rear windshield, the mounting angle θ may be 13.5°. The shortest distance between the front window frame or the rear window frame and the dielectric substrate 30 may be 30 mm.

The reflection coefficients S11 of the front windshield indicated by a dotted curve and of the rear windshield indicated by a solid curve roughly match with each other. A frequency band of electric wave used in the ITS (Intelligent Transport Systems) is 5.77 GHz to 5.85 GHz in Japan, 5.85 GHz to 5.925 GHz in North America, and 5.875 GHz to 5.905 GHz in Europe. As illustrated in FIG. 13, in any case where the vehicle window glass 100 is a front windshield and where the vehicle window glass 100 is a rear windshield, the antenna 101 resonates and the frequency is matched around a central frequency 5.89 GHz of the frequency band 5.77 GHz to 5.925 GHz used for electric waves for ITS.

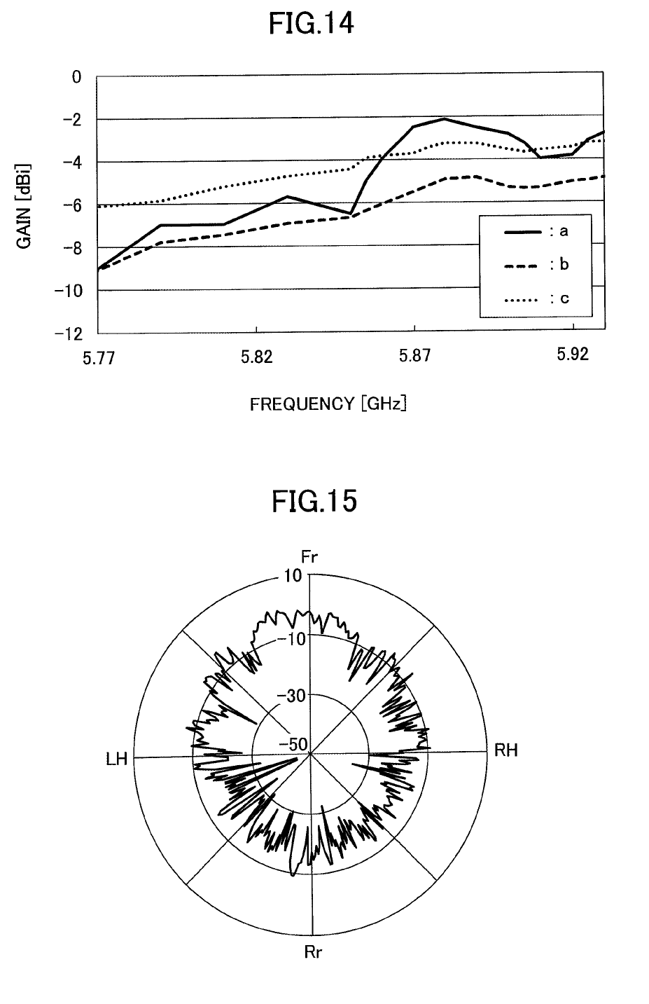

FIG. 14 is a diagram that depicts an example of results of measurement of an antenna gain of the antenna 101 mounted on an intermediate portion of an upper edge of the front windshield.

The measurement of antenna gain was performed by setting a vehicle center of a car, on which the front windshield with the antenna 101 was mounted, to a center of a turntable, and rotating the car by 360°. Data of antenna gain were measured, for each rotational angle of 1° and every 20 MHz, within a frequency range of 5.77 GHz to 5.93 GHz, in which an upper limit was slightly higher than the frequency band used for electric waves for ITS. Antenna gain was measured by changing an elevation angle between a transmission position of electric wave and the antenna 101 (assuming that an elevation angle of a surface parallel to the ground was 0°, and an elevation angle of the zenithal direction was 90°) and an azimuthal angle between the transmission position of electric wave and the antenna 101 (assuming that an azimuthal angle of a direction of vehicle front is 0°, and an azimuthal angle of right and left directions are ±90°).

In FIG. 14, data indicated by “a” represent antenna gains measured with the elevation angle of 0° and in the direction of vehicle front 0°. Data indicated by “b” represent average values of antenna gains measured at the elevation angle of 0° and in a front range of ±45° with respect to the direction of vehicle front. Data indicated by “c” represent average values of antenna gains measured in a range of elevation angle of 0° to 10°, every 2° (0°, 2°, 4°, 6°, 8°, and 10°) and in a front range of an azimuthal angle of ±45° (every 1° in a range of azimuthal angle of −45° to +45°). As illustrated in FIG. 14, relatively high antenna gain is obtained in the direction of vehicle front. The unit of antenna gain is dBi.

FIG. 15 is a diagram that depicts an example of results of measurement of a directivity of the antenna 101 mounted on a front windshield. FIG. 15 illustrates antenna gains measured at an elevation angle of 0° and with a frequency of 5.89 GHz. In FIG. 15, “Fr”, “Rr”, “RH”, and “LH” represent the vehicle front, the vehicle rear, the vehicle right, and the vehicle left when the vehicle is viewed from the zenith, respectively. The unit of the antenna gain is dBi. As illustrated in FIG. 15, an antenna gain in the longitudinal direction (particularly, towards the front of the vehicle) is higher compared with vehicle right and left directions.

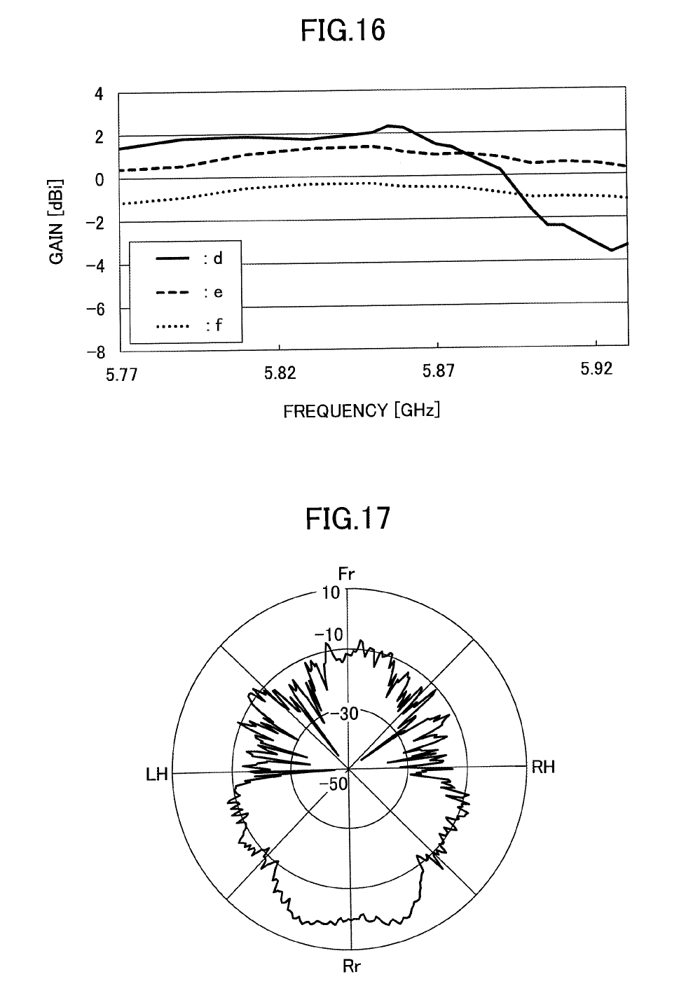

FIG. 16 is a diagram that depicts an example of results of measuring the antenna gain of the antenna 101 mounted on a rear windshield. In FIG. 16, data indicated by “d” represent antenna gains measured at an elevation angle of 0° and in a direction of vehicle rear 0°. Data indicated by “e” represent average values of antenna gains measured at an elevation angle of 0° and in a rear range of ±45° with respect to the direction of vehicle rear (every 1° in a range of azimuthal angle of −135° to +135°). Data indicated by “f” represent average values of antenna gains measured in a vertical range of an elevation angle of 10° and in a rear range of an azimuthal angle of ±45° with respect to the direction of vehicle rear. As illustrated in FIG. 16, a relatively high antenna gain is obtained in the direction of vehicle rear.

FIG. 17 is a diagram that depicts an example of results of measurement of a directivity of the antenna 101 mounted on a rear windshield. FIG. 17 illustrates antenna gains measured at an elevation angle of 0° and with a frequency of 5.89 GHz. In FIG. 17, “Fr”, “Rr”, “RH”, and “LH” represent the vehicle front, the vehicle rear, the vehicle right, and the vehicle left, respectively. The unit of the antenna gain is dBi. As illustrated in FIG. 17, the antenna gain in the longitudinal direction (particularly, vehicle rear) is higher compared with vehicle right and left directions.

In addition, when the reflection coefficient or the antenna gain was measured in FIGS. 13 to 17, dimensions of the respective members of the antenna 101, illustrated in FIG. 2, and a distance L20 between the antenna 101 and the vehicle window glass 100, illustrated in FIG. 12 are as follows (unit is mm):

L1: 25

L2: 25

L3: 10

L4: 1.4

L5: 0.5

L6: 11

L7: 11.5

L8: 13.5

L9: 3

L10: 25.2

L11: 1

L12: 6.5

L13: 4

L20: 3.

A vehicle antenna and a window glass according to the embodiment have been described above. However, the present invention is not limited to the embodiment, and various variations and modification, such as a combination with a part or all of another embodiment or substitution, may be made without deviating from the scope of the present invention.

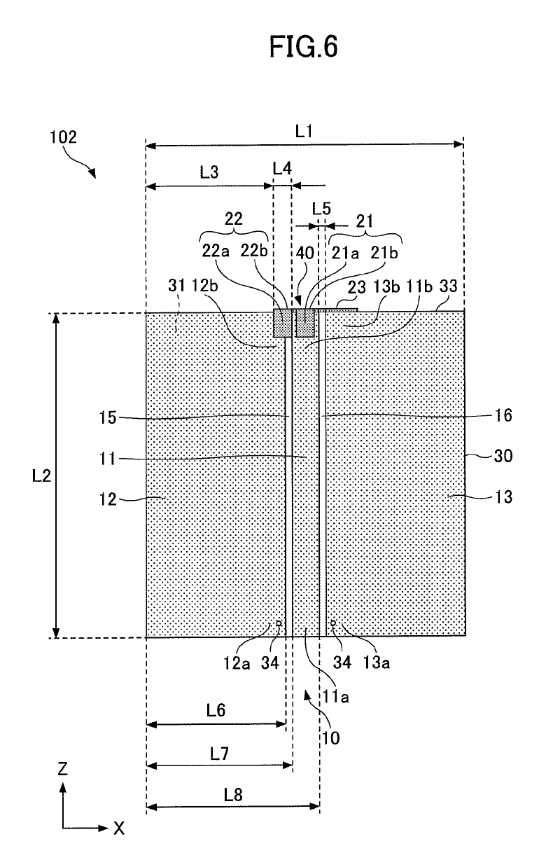

For example, the positions of the power feeding unit and the shorting unit may be switched. Moreover, in FIGS. 2 and 6, the connection part 22a may be coupled to the other end portion 13b of the ground conductor 13 instead of the end portion 12b. Then, the radiation unit 23 extends, in a planar view of the surface 31, to the ground conductor 12 side that is an opposite direction to the extension direction illustrated in FIG. 2.

Moreover, in FIG. 9, the shorting unit 52 may be coupled to the end portion 13b, instead of the end portion 12b.

Moreover, in FIGS. 2 and 6, the radiation unit 23 extends to the ground conductor 13 side, in the X-axis direction parallel to the edge surface 33. However, the radiation unit 23 may extend to the ground conductor 12 side. That is, the power feeding unit 21 may be coupled to an end portion of the radiation unit 23, and the shorting unit 22 may be coupled to an intermediate portion of the radiation unit 23.

In the first embodiment, the shapes of the power feeding unit 21 and the shorting unit 22 are not limited to an L-shape, but may be U-shaped, or may be J-shaped, for example.

In the first to third embodiments, the power feeding unit and the shorting unit are illustrated as extending in parallel to each other. However, the power feeding unit and the shorting unit are not restricted to extending in parallel to each other. Furthermore, the power feeding unit and the shorting unit are illustrated to have the same shape and the same size. However, the power feeding unit and the shorting unit may have different shapes and different sizes.

The frequency range for the vehicle antenna has been described assuming ITS. However, the frequency range is not limited to the described range, and may be a frequency range of a desired wireless service.

FIG. 12 illustrates that the antenna 101 is separated from the vehicle window glass 100 by a prescribed distance. However, the configuration is not limited to the described arrangement, and the antenna 101 may contact the vehicle window glass 100.

### REFERENCE SIGNS LIST

10,17 Coplanar Waveguide with Ground plane (CPWG)
11 signal conductor
12,13 ground conductor
14,54 ground plane
15,16 slot
20,40,50 inverted-F antenna
21,51 power feeding unit
22,52 shorting unit
23,43,53 radiation unit
30 dielectric substrate
31,32 surface
33 edge surface
34 through hole
101,102,103 antenna
110 window glass system

What is claimed is:

1. A vehicle antenna, comprising:
a coplanar wave guide including a planar dielectric body, a signal conductor arranged on the dielectric body, and a pair of ground conductors that hold both sides of the signal conductor via slots;
a ground plane provided on an opposite side of the dielectric body from the signal conductor and the ground conductors; and
an inverted-F antenna including a power feeding unit coupled to the signal conductor, a shorting unit coupled to one of the ground conductors, and a radiation unit coupled to an end portion of the power feeding unit and coupled to an end portion of the shorting unit, the radiation unit extending in a prescribed extension direction,
wherein the radiation unit is positioned on the ground plane side with respect to the dielectric body.

2. The vehicle antenna according to claim 1,
wherein a length of the radiation unit in a direction that the radiation unit extends is less than or equal to a length of the ground plane in the direction that the radiation unit extends.

3. The vehicle antenna according to claim 1,
wherein the radiation unit faces the ground plane.

4. The vehicle antenna according to claim 2,
wherein the radiation unit faces the ground plane.

5. The vehicle antenna according to claim 1,
wherein the radiation unit is inclined with respect to the ground plane.

6. The vehicle antenna according to claim 2,
wherein the radiation unit is inclined with respect to the ground plane.

7. The vehicle antenna according to claim 1,
wherein the power feeding unit and the shorting unit extend beyond the dielectric body.

8. The vehicle antenna according to claim 2,
wherein the power feeding unit and the shorting unit extend beyond the dielectric body.

9. The vehicle antenna according to claim 3,
wherein the power feeding unit and the shorting unit extend beyond the dielectric body.

10. The vehicle antenna according to claim 4,
wherein the power feeding unit and the shorting unit extend beyond the dielectric body.

11. The vehicle antenna according to claim 5
wherein the power feeding unit and the shorting unit extend beyond the dielectric body.

12. The vehicle antenna according to claim 6,
wherein the power feeding unit and the shorting unit extend beyond the dielectric body.

13. The vehicle antenna according to claim 1,
wherein the power feeding unit and the shorting unit extend inside the dielectric body.

14. The vehicle antenna according to claim 2,
wherein the power feeding unit and the shorting unit extend inside the dielectric body.

15. The vehicle antenna according to claim 3,
wherein the power feeding unit and the shorting unit extend inside the dielectric body.

16. The vehicle antenna according to claim 4,
wherein the power feeding unit and the shorting unit extend inside the dielectric body.

17. The vehicle antenna according to claim 5,
wherein the power feeding unit and the shorting unit extend inside the dielectric body.

18. The vehicle antenna according to claim 6,
wherein the power feeding unit and the shorting unit extend inside the dielectric body.

19. A window glass comprising:
the vehicle antenna according to claim 1; and
a vehicle window glass.

20. The window glass according to claim 19,
wherein the radiation unit is located between the ground plane and the vehicle window glass.
